(19) United States
(12) Patent Application Publication
(10) Pub. No.: US 2010/0219756 A1
(43) Pub. Date: Sep. 2, 2010

(54) Wiper lights device

(76) Inventor: Bruce L. Green, Bellport, NY (US)

Correspondence Address: RUTH EURE, 4795 EDISON AVENUE, BOULDER, CO, 80301, US

(21) Appl. No.: 12/658,367

(22) Filed: Feb. 8, 2010

Related U.S. Application Data
(60) Provisional application No. 61/206,984, filed on Feb. 6, 2009.

(51) Int. Cl. B60Q 1/26

(52) U.S. Cl. 315/80

(57) ABSTRACT

Wiper Lights Device described in the present patent application is a system which automatically turns on the automobile's headlights and tail lights upon the activation of windshield wipers

### CLAIM OF PRIORITY

This patent application claims priority under 35 USC 119 (e) (1) from U.S. Provisional Patent Application Ser. No. 61/206,984 filed Feb. 6, 2009, of common inventorship herewith entitled, “Wiper Lights Device.”

### FIELD OF THE INVENTION

The present invention pertains to the field of automotive safety devices, and more particularly to the field of windshield wipers and headlights.

### BACKGROUND OF THE INVENTION

The prior art has put forth several designs pertaining to the operation of windshield wipers and headlights. Among these are:

U.S. Pat. No. 4,956,562 to Benedict et al describes a headlight, windshield wiper control system utilizing a gating circuit that operates relays to the Headlights when the wipers are activated.

U.S. Pat. No. 3,608,123 to Champigny is directed to a wiper for a headlight.

U.S. Pat. No. 3,456,278 to Many et al is directed to a vehicle headlight clearing system.

None of theses prior art references describe the present invention.

### SUMMARY OF THE INVENTION

It is an object of the present invention to provide a system which automatically turns on the automobile's headlights upon activation of the windshield wipers.

### BRIEF DESCRIPTION OF THE DRAWINGS

FIG. 1 is a perspective view of a typical automobile.

FIG. 2 is a perspective view of a typical automobile utilizing the present invention showing the wipers engaged and the headlights on.

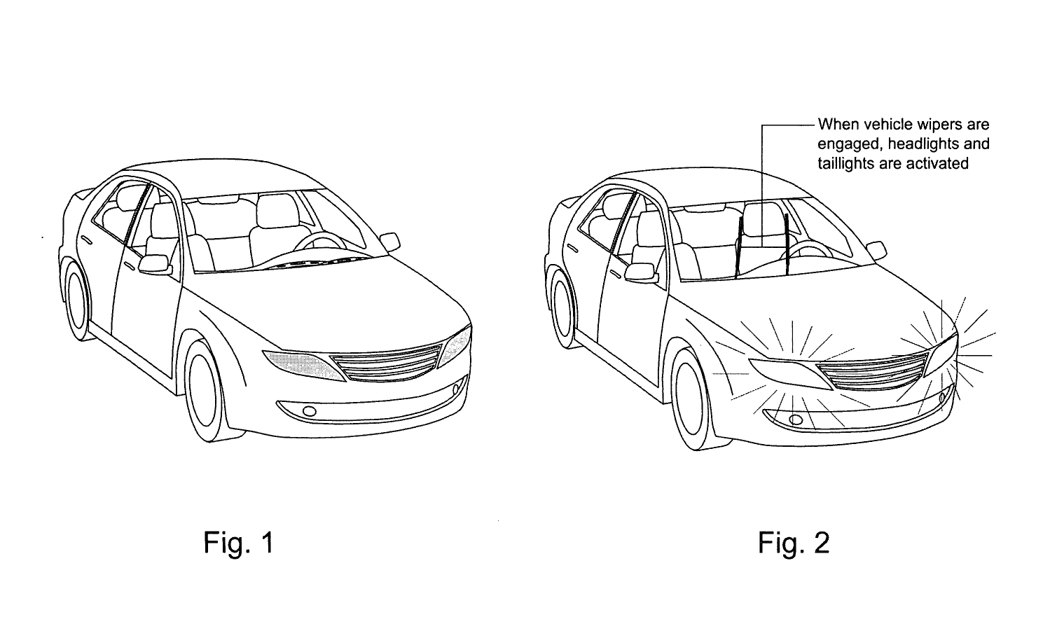

### DETAILED DESCRIPTION OF THE INVENTION

Over the last decade, increasing emphasis has been placed on providing safer vehicles for the driving public. Many innovative and beneficial changes have come about as a result of this increasing awareness of the need for safer vehicles. Radial tires, anti-lock braking systems, driver and passenger air bags, represent just a few of the potentially life saving devices which have been incorporated into vehicles being produced today. The latest device being incorporated, on an optional basis, is air bags positioned in the doors of vehicles to provide protection for side impact collisions.

There is one area of safety which seems to have been overlooked in the development of new vehicle products and systems which would add to the overall safety of the vehicle. This area is state requirements which mandate that automobile headlights must be turned on any time the vehicle's windshield wipers are employed. In an effort to increase motor vehicle safety and provide automobile drivers with a convenient method of obeying the law, the present invention was developed and is hereinafter referred to as Wiper Lights Device.

Wiper Lights Device is a system which automatically turns on the automobile's headlights and tail lights upon the activation of windshield wipers.

The present invention comprises a switch which turns on the headlights of the automobile when the windshield wipers are activated.

This system helps motorist to increase their visibility when driving in fog, rain, snow, or other inclement weather conditions. This system is especially helpful to those motorists who often forget to employ their headlights with their wipers, protecting them from receiving a citation and increasing road safety. The Wiper Lights Device will not only help motorists to obey the law, it could reduce the chance of causing an automobile accident. By preventing accidents, the present invention will also save money for the insurance companies by way of fewer accident claims.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A device for turning on the headlights and tail lights of an automobile when the windshield wipers are engaged, essentially as described herein.

2. The device of claim 1 wherein the device is configured to be incorporated into an automobile at the time of original manufacture.

3. The device of claim 1 wherein the device is configured to be incorporated into an automobile after the automobile has been manufactured.
